(19) United States
(12) Patent Application Publication
(10) Pub. No.: US 2013/0155716 A1
(43) Pub. Date: Jun. 20, 2013

(54) LIGHTING FIXTURE

(71) Applicants: Ping-Yeng Chen, Taichung City (TW); Kuo-Jui Huang, Taichung City (TW)

(72) Inventors: Ping-Yeng Chen, Taichung City (TW); Kuo-Jui Huang, Taichung City (TW)

(21) Appl. No.: 13/714,436

(22) Filed: Dec. 14, 2012

(30) Foreign Application Priority Data
Dec. 19, 2011 (TW) 100147180

(51) Int. Cl. F21V 8/00

(52) U.S. Cl. CPC G02B 6/0001
USPC 362/555

(57) ABSTRACT

A light fixture including at least one light emitting device and a light-guiding pillar is provided. The light emitting device is adapted to emit a light beam. The light-guiding pillar has a light incident surface, an end surface opposite to the light incident surface, and a peripheral surface connecting the light incident surface to the end surface. The peripheral surface includes a smooth curved surface, a fillister surface connected to the smooth curved surface, and a reflective surface connected to the fillister surface. The light emitting device is disposed beside the light incident surface. The fillister surface is disposed at two opposite sides of the reflective surface. Extending directions of a plurality of fillisters on the fillister surface are substantially parallel to an extending direction of the light-guiding pillar.

### CROSS-REFERENCE TO RELATED APPLICATION

This application claims the priority benefit of Taiwan application serial no. 100147180, filed on Dec. 19, 2011. The entirety of the above-mentioned patent application is hereby incorporated by reference herein and made a part of this specification.

### BACKGROUND

1. Technical Field

The disclosure relates to a lighting fixture, and more particularly to a lighting fixture having a light-guiding pillar

2. Related Art

Light emitting diode (LED) has been widely used in the lighting fixture. The LED is a spot light source. Hence, when the spot light source is used in general purposes, the spot light source may easily cause people's eyes to feel uncomfortable while people are directly looking at the spot light source. To solve the problem, it is proposed in the related art that the LED is disposed at one end of a light-guiding pillar to distribute the light beams emitted from the LED uniformly.

The researchers often set to increase the luminous efficiency of the light-guiding pillar for increasing the total luminous efficiency of the lighting fixture. In the related art, the luminous efficiency is increased by disposing a particular structure on a light incident surface of the light-guiding pillar, or by increasing the area of the reflective bar positioned at the light-guiding pillar. However, either of the above designs may result in the decrease in uniformity of the light-guiding pillar.

### SUMMARY

The disclosure provides a lighting fixture, which can increase the total luminous efficiency with the influence to the uniformity as little as possible.

A lighting fixture including at least one light emitting device and a light-guiding pillar is provided. The light emitting device is adapted to emit a light beam. The light-guiding pillar has a light incident surface, an end surface opposite to the light incident surface, and a peripheral surface connecting the light incident surface to the end surface. The peripheral surface includes a smooth curved surface, a fillister surface connected to the smooth curved surface, and a reflective surface connected to the fillister surface. The light emitting device is disposed beside the light incident surface. The fillister surface is disposed at two opposite sides of the reflective surface. Extending directions of a plurality of fillisters on the fillister surface are substantially parallel to an extending direction of the light-guiding pillar.

Based on the above, by configuring the fillister surface on a portion of the light-guiding pillar, and making the extending directions of the fillisters substantially parallel to an extending direction of the light-guiding pillar, the lighting fixture of the disclosure not only can increase the luminous efficiency of the light-guiding pillar and further increase the total luminous efficiency of the lighting fixture but also can decrease the level of influence on the uniformity. Besides, in the lighting fixture of the invention, the peripheral surface of the light-guiding pillar includes both the smooth curved surface and the fillister surface, such that the light beam emitted by the lighting fixture may not be overly diffused. Hence, the lighting fixture of the disclosure has superior lighting quality.

In order to make the aforementioned and other features and advantages of the disclosure more comprehensible, embodiments are described in detail below with accompanying figures.

### BRIEF DESCRIPTION OF THE DRAWINGS

FIG. 1 is a schematic three-dimensional view of a lighting fixture according to an embodiment of the invention.

FIG. 2 is a schematic cross-sectional view of the lighting fixture depicted in

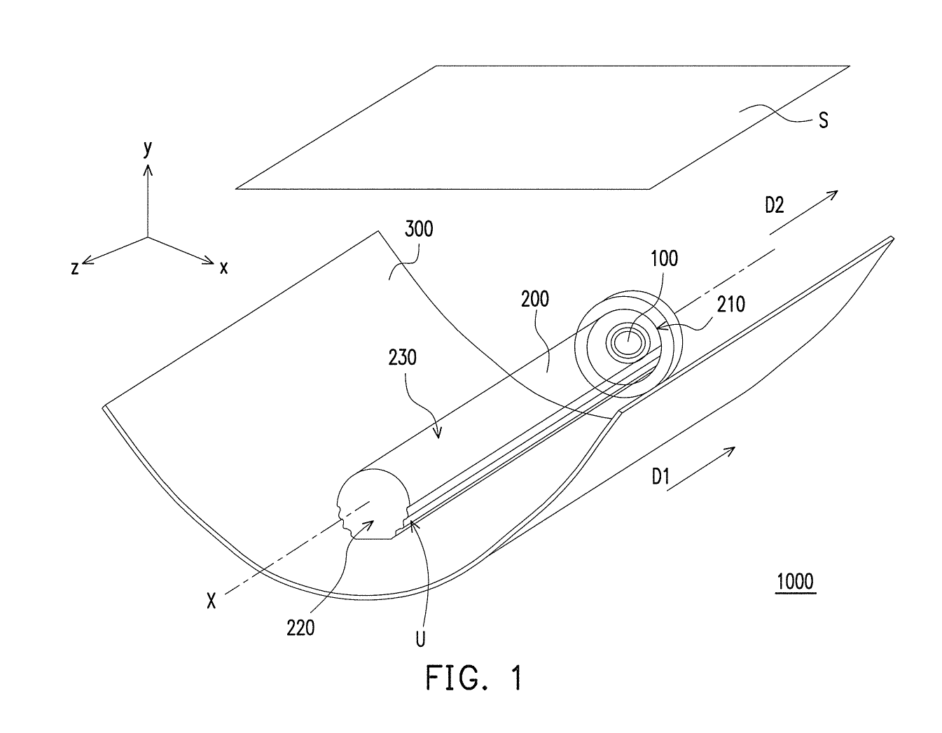

FIG. 1.

FIG. 3 is a schematic cross-sectional view of a light-guiding pillar according to another embodiment of the invention.

FIG. 4 is a schematic cross-sectional view of a light-guiding pillar according to yet another embodiment of the invention.

FIG. 6A and FIG. 5A respectively show the cross-sections of the light-guiding pillar in the reference embodiment and the present embodiment.

FIG. 5B and FIG. 6B respectively show the light-emitting distribution of the light-guiding pillar in the present embodiment and the reference embodiment.

FIG. 6C and FIG. 5C illustrate the light pattern described in the reference embodiment and in the present embodiment, respectively.

FIG. 6D and FIG. 5D illustrate the light emitting distribution of the light-guiding pillar described in the reference embodiment and in the present embodiment, respectively.

### DETAILED DESCRIPTION OF DISCLOSED EMBODIMENTS

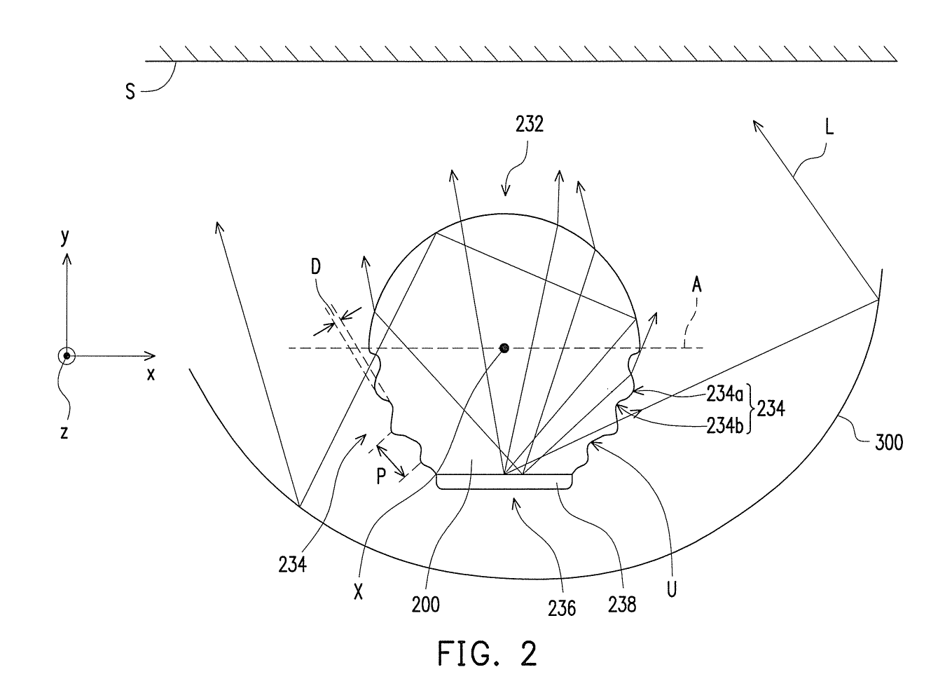

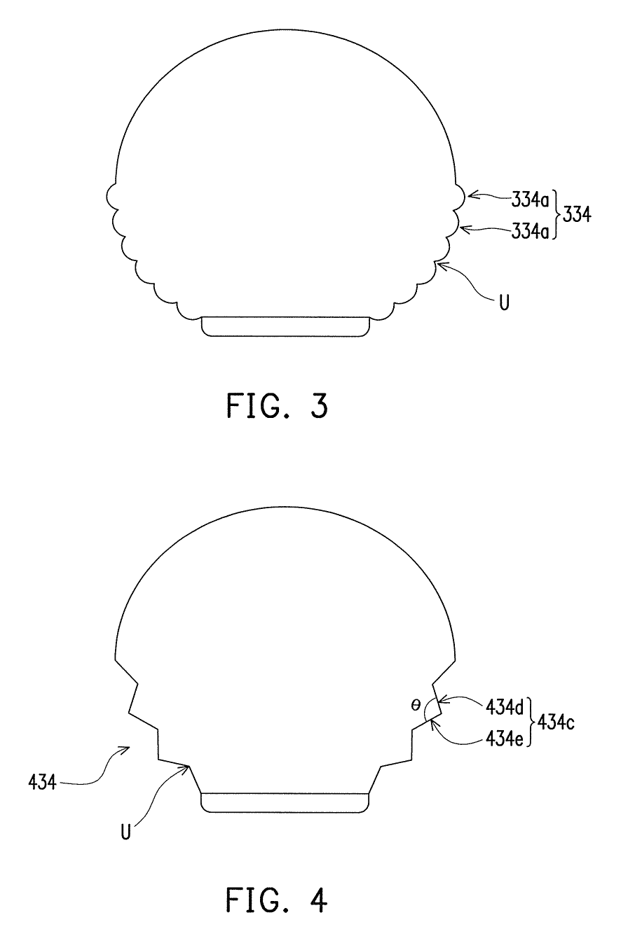

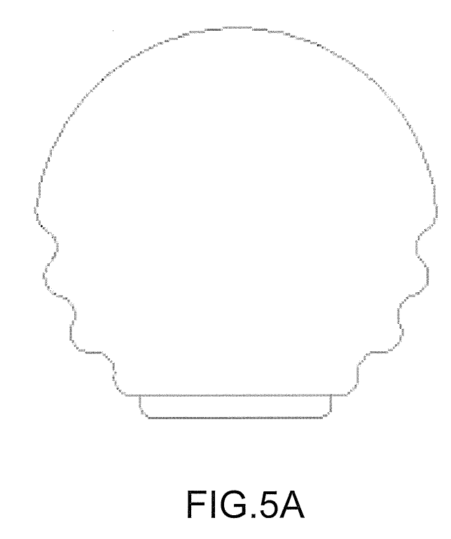

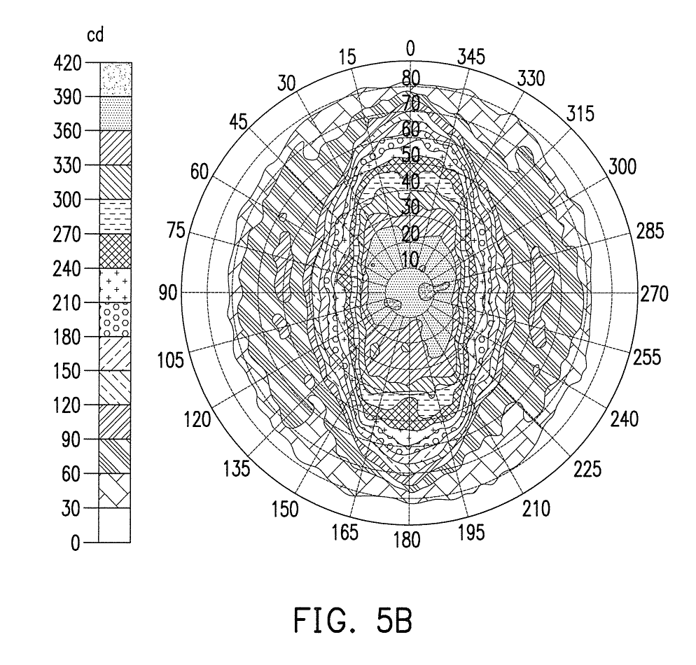

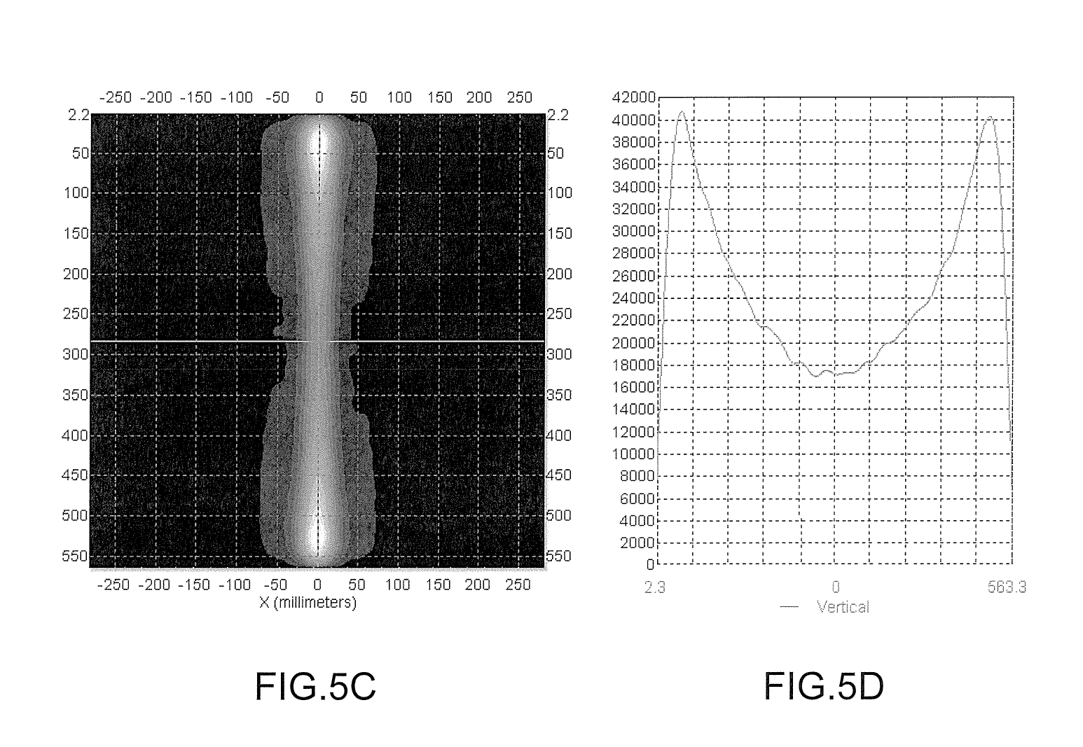

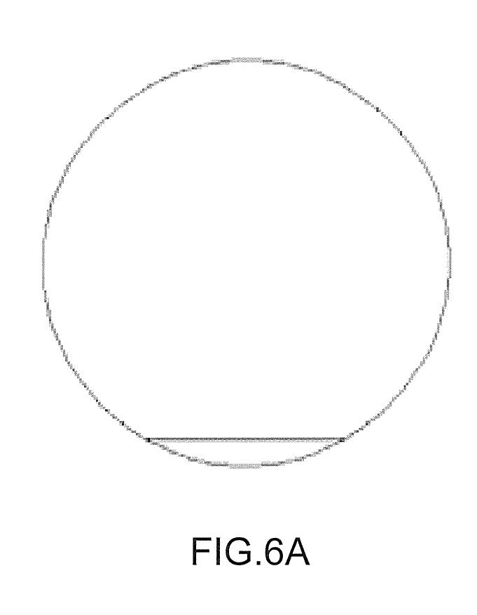

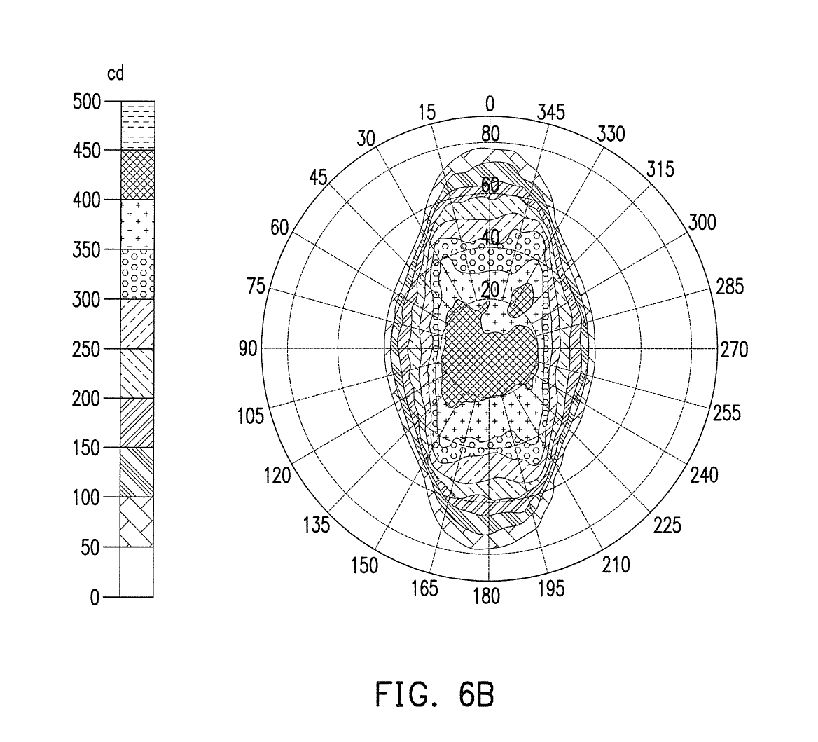

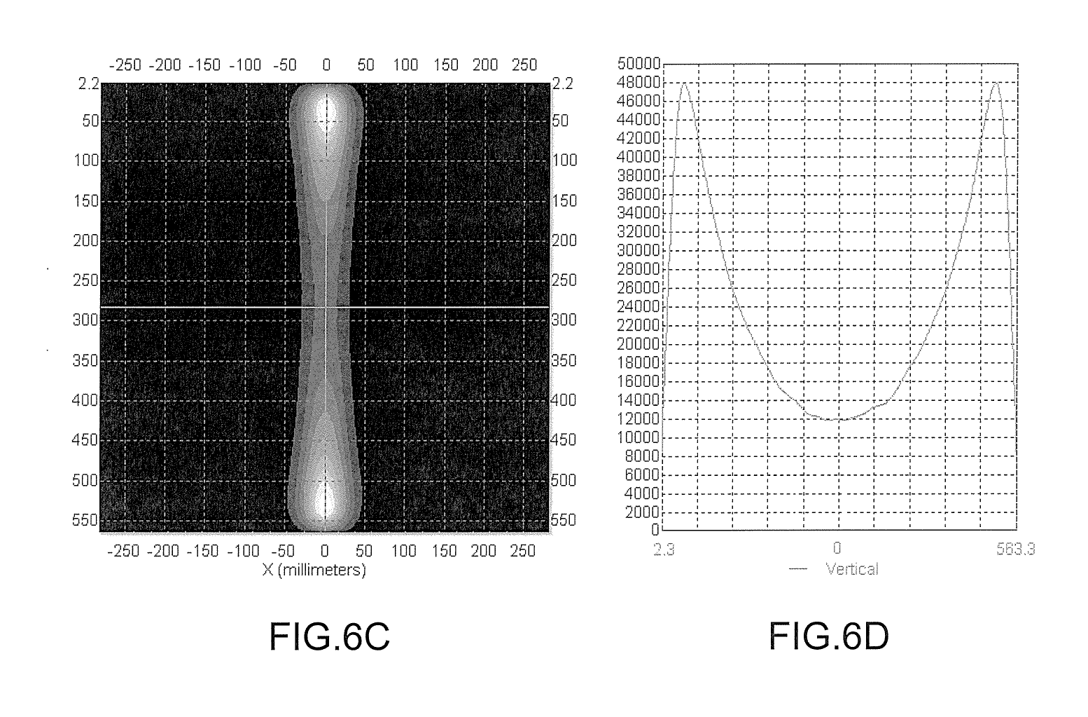

FIG. 1 is a schematic three-dimensional view of a lighting fixture according to an embodiment of the invention. FIG. 2 is a schematic cross-sectional view of the lighting fixture depicted in FIG. 1. With reference to FIG. 1 and FIG. 2 together, a light fixture 1000 includes at least one light emitting device 100 and a light-guiding pillar 200. The light emitting device 100 is adapted to emit a light beam L. In the present embodiment, the light emitting device 100 may be, for example but not limited to, light emitting diode (LED).

The light-guiding pillar 200 has a light incident surface 210, an end surface 220 opposite to the light incident surface 210, and a peripheral surface 230 connecting the light incident surface 210 to the end surface 220. The light emitting device 100 may be disposed beside the light incident surface 210, and the light beam L emitted by the light emitting device 100 may enter the light-guiding pillar 200 from the light incident surface 210. The peripheral surface 230 includes a smooth curved surface 232, a fillister surface 234 connected to the smooth curved surface 232, and an reflective surface 236 connected to the fillister surface 234 (as illustrated in FIG. 2), wherein the proportion of the areas of the smooth curved surface 232, the fillister surface 234, and the reflective surface 236 in the overall area of the peripheral surface 230 can be designed adaptively based on the actual need. Additionally, in the present embodiment, a material of the light-guiding pillar 200, for example, is polymethylmethacrylate (PMMA), and the light-guiding pillar 200 may be formed by extrusion molding. In other words, while the light-guiding pillar 200 of the disclosure has particular structures such as the fillister surface 234, the structures are configured along the extending direction of the light-guiding pillar 200, and thus no additional process is required; thereby, the cost and time of fabricating the light-guiding pillar 200 can be saved.

As shown in FIG. 1 and FIG. 2, note that the fillister surface 234 of the embodiment may be formed at two opposite sides of the reflective surface 236, and the fillister surface 234 having a plurality of fillisters U thereon may destroy the total internal reflection of light beams in the light-guiding pillar 200, and the light beams are reflected by the reflective surface 236 and then emitted from the fillister surface 234 to increase the luminous efficacy of the light-guiding pillar 200 and to further increase the total luminous efficacy of the lighting fixture 1000. On the other hand, the extending directions D1 of the fillisters U are substantially parallel to the extending direction D2 of the light-guiding pillar 200; thereby the included angle between the fillisters U and the direction that the light travels is not overly small, and the light beams are thus not apt to deflect from the light-guiding pillar 200. That is, with the design of the fillister surface 234 and the extending directions of the fillisters U on the fillister surface 234 in the present embodiments, the luminous efficacy can be increased without sacrificing the uniformity.

The smooth curved surface 232 and the fillister surface 234 of the embodiment may be located at two opposite sides of the cross-section A of the light-guiding pillar 200, and the optical axis X of the light emitting device 100 is positioned on the cross-section A. In other words, when users look toward the -y direction, the users observe the smooth curved surface 232 but are not prone to perceive the fillisters U which are positioned at the rear half of the peripheral surface 230. That is, the design of fillisters U in the lighting fixture 1000 of the embodiment may not affect the visual impression of the users. Besides, the design that keeps both the smooth curved surface 232 and the fillister surface 234 on the peripheral surface 230 may prevent the light beams from over diffusion, and thus the illumination of the lighting fixture 1000 at the direction of front view is not affected. As such, the lighting fixture of the present embodiment is applicable to illumination in a conference room or may serve as a table lamp. According to the embodiment, a pitch P between the fillisters U may be approximately equal to or smaller than 4 mm, and a depth D of the fillisters U may be approximately equal to or smaller than 2 mm. However, the disclosure is not limited thereto. Instead, the pitch P and the depth D of the fillisters U can be adjusted based on actual demands.

The shape of the fillister surface 234 may be of various kinds. For example, the fillister surface 234 of the embodiment includes a plurality of strip convex surfaces 234a and a plurality of strip concave surfaces 234b. The strip convex surfaces 234a and the strip concave surfaces 234b may extend toward a direction which is parallel to the extending direction D2 of the light-guiding pillar 200. The strip convex surfaces 234a and the strip concave surfaces 234b are interlaced and connected with each other; the strip concave surfaces 234b form the fillisters U. Particularly, each of the strip convex surfaces 234a may partially be a cylindrical convex surface, and each of the strip concave surfaces 234b may partially be a cylindrical concave surface. In other words, the cross-section shape of the fillister surface 234 in the present embodiment can be an undulating shape.

However, the shape of the fillister surface 234 of the disclosure is not limited to the above description. FIG. 3 is a schematic cross-sectional view of a light-guiding pillar according to another embodiment of the invention. With reference to FIG. 3, in another embodiment of the invention, a fillister surface 334 includes a plurality of strip convex surfaces 334a connected to one another, and two adjacent strip convex surfaces 334a form the fillister U. Furthermore, each of the strip convex surfaces 334a may partially be a cylindrical convex surface. It should be mentioned that the adjacent strip convex surfaces 334a may be connected with each other directly or connected through other structures on the fillister surface 334.

FIG. 4 is a schematic cross-sectional view of a light-guiding pillar according to yet another embodiment of the invention. With reference to FIG. 4, in yet another embodiment of the invention, a fillister surface 434 includes a plurality of surface units 434c connected to one another. Each surface unit 434c includes a first strip inclined plane 434d and a second strip inclined plane 434e inclined at opposite directions and connected to each other. Two adjacent surface units 434c form the fillister U. Furthermore, the first strip inclined plane 434d and the second strip inclined plane 434e may directly connect with each other. The included angle θ between the first strip inclined plane 434d and the second strip inclined plane 434e may be from about 100° to about 140°.

Again, with reference to FIG. 1 and FIG. 2, the lighting fixture 1000 of the embodiment may further include a reflective cover 300. The fillister surface 234 is positioned between the smooth curved surface 232 and the reflective cover 300. The light beam L emitted from the light emitting device 100 enters the light-guiding pillar 200 via the light incident surface 210; then, the light beam L is reflected by the reflective layer 238 disposed on the reflective surface 236 to the smooth curved surface 232 or the fillister surface 234, and is further emitted from the smooth curved surface 232 or the fillister surface 234. It should be mentioned that in the present embodiment, a portion of the light beam L emitted from the fillister surface 234 may be transmitted in the direction which is distant from an intended illumination surface S after departing from the light-guiding pillar 120. At this time, the lighting fixture 1000 may use the reflective cover 300 to reflect the light beam L and further allows the light beam L to be transmitted to the intended illumination surface S, such that the center luminance of the lighting fixture 1000 may be further increased according to the present embodiment.

To be more specific, the reflective cover 300 of the present embodiment may protrude toward a direction distant from the light-guiding pillar 120 to effectively transmit the light beam L to the intended illumination surface S. However, the shape of the reflective cover is not limited thereto, as long as the reflective cover can transmit part of the light beams (emitted from the fillister surface) to the intended illumination surface S.

| | Luminous | Total | | |
|---|---|---|---|---|
| | efficiency of the | luminous | | Total |
| | light-guiding | efficiency | Uniformity | luminous |
| | pillar in the | of the | of the | efficiency of |
| | front-view | light-guiding | light-guiding | the |
| | direction | pillar | pillar | lighting fixture |
| Reference | 62.7% | 68.1% | 47.9% | 63.3% |
| Embodiment | | | | |
| Present | 72.7% | 83.6% | 60.5% | 72.6% |
| Embodiment | | | | |

Table 1 has listed the luminous efficiency of the light-guiding pillar in the front-view direction, the total luminous efficiency, and the uniformity of visual effects in the present embodiment and the reference embodiment, respectively. Table 1 has also listed the total luminous efficiency of the lighting fixture in the present embodiment and the reference embodiment, respectively. With reference to FIG. 5A˜5D or Table 1 and the relevant descriptions, FIG. 6A and FIG. 5A respectively show the cross-sections of the light-guiding pillar in the reference embodiment and the present embodiment, while the main difference the reference embodiment and the present embodiment between lies in that the light-guiding pillar of the present embodiment has the fillister surface. FIG. 5B and FIG. 6B respectively show the light-emitting distribution of the light-guiding pillar in the present embodiment and the reference embodiment, and it can be understood that the light-emitting distribution of the light-guiding pillar of the present embodiment is wider than that of the reference embodiment. Moreover, both of the luminous efficacy of the light-guiding pillar in the front-view direction and the total luminous efficacy of the light-guiding pillar of the present embodiment are higher than those of the reference embodiment.

FIG. 6C and FIG. 5C illustrate the light pattern described in the reference embodiment and in the present embodiment, respectively. FIG. 6D and FIG. 5D illustrate the light emitting distribution of the light-guiding pillar described in the reference embodiment and in the present embodiment, respectively. It can be known from FIG. 6C, FIG. 5C, FIG. 6D, FIG. 5D and the Table 1 that the light-guiding pillar of the present embodiment has better uniformity than that of the reference embodiment. In the present embodiment, the uniformity is represented as {1−(Lₘᵢₙ/Lₘₐₓ)}, wherein Lₘₐₓ is the maximum value of the light intensity distribution of light-guiding pillar, and Lₘᵢₙ is the minimum value of the same. With reference to Table 1, it can be known that the lighting fixture of the present embodiment has higher total luminous efficacy than the conventional lighting fixture.

Based on the above, by the design of the fillisters on the fillister surface of the peripheral surface of the light-guiding pillar, the light-guiding pillar of the lighting fixture described in one embodiment of the disclosure can have the improved luminous efficacy, and the total luminous efficacy of the lighting fixture can also be increased. In addition, compare to the conventional lighting fixture, the lighting fixture described herein has the fillisters extended in an axial direction to mitigate the problem of uniformity. Besides, in the lighting fixture described an embodiment of the invention, the peripheral surface of the light-guiding pillar has the smooth curved surface positioned at the front side and the fillister surface positioned at the back side, such that users are rather not apt to notice the fillisters on the fillister surface, and thus the lighting fixture can have a better visual effect. At the same time, the light-guiding pillar having both the smooth curved surface and the fillister surface may prevent the light beams emitted from the lighting fixture from over diffusion, so as not to affect the illumination of the lighting fixture in the direction of front view; thus, the lighting fixture described in an embodiment of the disclosure is adaptive to be used as the illumination in a conference room or used a table lamp.

Additionally, according to an embodiment of the invention, the lighting fixture may further include a reflective cover. The reflective cover may reflect part of the light beam (emitted from the fillister surface) to a surface intended to be lightened, and thereby the center illumination of the lighting fixture is further improved.

Although the disclosure has been disclosed above by the embodiments above, they are not intended to limit the invention. Any person who is skilled in the art can make some modifications and alteration without departing from the spirit and scope of the invention. Therefore, the protecting range of the present disclosure falls in the appended claims.

What is claimed is:

1. A lighting fixture comprising:
at least one light emitting device adapted to emit a light beam; and
a light-guiding pillar having a light incident surface, an end surface opposite to the light incident surface, and a peripheral surface connecting the light incident surface to the end surface, wherein the peripheral surface includes a smooth curved surface, a fillister surface connected to the smooth curved surface, and a reflective surface connected to the fillister surface, the light emitting device is disposed besides the light incident surface, the fillister surface is disposed at two opposite sides of the reflective surface, and extending directions of a plurality of fillisters on the fillister surface are substantially parallel to an extending direction of the light-guiding pillar.

2. The lighting fixture of claim 1, wherein the fillister surface comprises a plurality of strip convex surfaces and a plurality of strip concave surfaces, the strip convex surfaces and the strip concave surfaces are alternately arranged and connected to one another, and the strip concave surfaces form the fillisters.

3. The lighting fixture of claim 2, wherein each of the strip convex surfaces is cylindrical convex in a portion, and each of the strip concave surfaces is cylindrical concave in a portion.

4. The lighting fixture of claim 1, wherein a cross-section shape of the fillister surface is an undulating shape.

5. The lighting fixture of claim 1, wherein the fillister surface comprises a plurality of strip convex surfaces connected to one another and two adjacent strip convex surfaces of the strip convex surfaces form one of the fillisters.

6. The lighting fixture of claim 5, wherein each of the strip convex surfaces is cylindrical convex in a portion.

7. The lighting fixture of claim 1, wherein the fillister surface includes a plurality of surface units connected to one another, each of the surface units includes a first strip inclined plane and a second strip inclined plane inclined at opposite directions and connected to each other, and two adjacent surface units of the surface units form one of the fillisters.

8. The lighting fixture of claim 7, wherein the first strip inclined plane and the second strip inclined plane are directly connected to each other.

9. The lighting fixture of claim 8, wherein the included angle between the first strip inclined plane and the second strip inclined plane is from about 100 to about 140 degrees.

10. The lighting fixture of claim 1, wherein the pitch between the fillisters is approximately equal to or smaller than 4 mm.

11. The lighting fixture of claim 1, wherein the depth of the fillisters is approximately equal to or smaller than 2 mm.

12. The lighting fixture of claim 1, further comprising a reflective cover, the fillister surface being disposed between the smooth curved surface and the reflective cover.

13. The lighting fixture of claim 12, wherein the light beam passes through the light-guiding pillar via the fillister surface and is transmitted to the reflective cover, and the reflective cover protrudes toward a direction distant from the light-guiding pillar.
